(19) United States
(12) Patent Application Publication
(10) Pub. No.: US 2011/0148769 A1
(43) Pub. Date: Jun. 23, 2011

(54) CHINESE CHARACTER INPUT METHOD ADAPTING FOR CHINESE TEACHING

(75) Inventor: Yu Chen, Beijing (CN)

(73) Assignee: BEIJING UI GLOBAL CO., LTD., Beijing (CN)

(21) Appl. No.: 12/995,951

(22) PCT Filed: Jun. 2, 2008
(86) PCT No.: PCT/CN2008/071162

§ 371 Date: Mar. 2, 2011

(51) Int. Cl. G06F 3/02

(52) U.S. Cl. 345/171

(57) ABSTRACT

This Invention discloses a Chinese character input method adapting for teaching, including the procedure for inputting the stroke-type-code-element corresponds to the initial stroke of the Chinese character to be entered at least, and the sequentially inputting all the Pinyin-letters-code-elements that form the Pinyin of the Chinese character to be entered. The useful effect of this Invention lies in the fact that through the above input method, the beginners for learning Chinese are allowed to review the pronunciation of this Chinese character at the same time while it is entered, and the memory effect is thereby enhanced through remembrance of the initial stroke and the final stroke of the Chinese character to review the shape of this Chinese character, so as to expedite the progress on learning the Chinese characters.

This application claims priority to International Application No. PCT/CN2008/071162, filed on Jun. 2, 2008, which is incorporated herein by reference in its entirety.

### FIELD OF THE INVENTION

This invention relates to a Chinese character input method, and in particularly, a kind of Chinese character input method typical of shape-sound combined codes.

### BACKGROUND OF THE INVENTION

In the existing technology, approximately four types of coding input methods are available, including sound code, shape code, shape-sound combined code, and digital code. Among these methods, the digital code is relatively less used. The advantage of sound code is easy to learn, in compliance with the character standard and thinking habit, while its disadvantage is high coincident code rate, slow speed of input, and unable to input unreadable characters. The shape code is characterized by the advantage of low coincident code rate, fast speed of input, and able to input the unacquainted characters, and the disadvantage of complicated rules, high difficulty for learning, and liable to deviating from the character standard. Compared with the shape code, the shape-sound combined code has reduced the difficulty for memory, while has also reduced the coincident code rate for individual characters as compared with sound code, for which it has been favored by some coding researchers.

However, the existing coding method for shape-sound combined code is not designed for the beginners of Chinese characters. Speaking from the beginners, it is often the most important to correctly write out the Chinese character and clearly remember the pronunciation of this Chinese character. On this account, there is such a need in the existing technology, namely to accurately input Chinese characters, through the combination of sound and shape codes, so as to help to memorize the pronunciation of the entered Chinese character at the same time.

Contents of Invention

This Invention aims to provide a group of Chinese character input methods, which can not only facilitate the input of Chinese characters, but also intensify the memory of the shapes and the pronunciations of the entered Chinese characters at the same time.

In order to achieve the above-mentioned objective, this invention has disclosed a kind of input method for Chinese characters adapting for teaching, and this method includes the following steps:

inputting the stroke-type-code-element or the stroke-code-element that corresponds to the initial stroke of Chinese character to be entered at least, and,

sequentially inputting all the Pinyin-letters-code-elements that form the Pinyin of the Chinese character to be entered.

Preferably, after the step of inputting the stroke-type-code-element or the stroke-code-element that corresponds to the initial stroke of the Chinese character to be entered, and before the step of sequentially inputting all the Pinyin-letters-code-elements that form the Pinyin of the Chinese character to be entered, a step is additionally included of inputting the stroke-type-code-element or the stroke-code-element that corresponds to the final stroke of the Chinese character to be entered.

Preferably, the input of mentioned code element may be achieved through finger click or touch of corresponding key element, and also may be achieved through click of correspondingly key element by means of tools or in the form of writing by means of tools.

Preferably, both of the stroke-type-code-element of the initial stroke and the stroke-type-code-element of the final stroke are respectively divided into five types including the horizontal-type stroke-code-elements, the vertical-type stroke-code-elements, the left-falling-type stroke-code-elements, the dot-and-right-falling-type stroke-code-elements, and the turning-type stroke-code-elements, wherein the horizontal-type stroke-code-elements are allocated to the key element F, the vertical-type stroke-code-elements are allocated to the key element H, the left-falling-type stroke-code-elements are allocated to the key element J, the dot-right-falling-type stroke elements are allocated to the key element A, and the turning-type stroke-code-elements are allocated to the key element S, and correspondingly thereto, both of the mentioned stroke-type-code-element of initial stroke and the stroke-type-code-element of final stroke are one letter, respectively.

Preferably, the horizontal-type strokes are divided into horizontal-stroke [symbol] and rising-stroke [symbol] the vertical-type strokes are divided into vertical-stroke [symbol] and vertical-hook-stroke [symbol] the left-falling-type strokes are divided into left-falling-stroke [symbol] left-falling-turning-stroke [symbol] and left-falling-dot-stroke [symbol] the dot-left-falling-type strokes are divided into left-dot-stroke [symbol] right-dot-stroke [symbol] right-falling-stroke [symbol] and flattened-right-falling-stroke [symbol] the turning-type strokes are divided into horizontal-turning-stroke [symbol] horizontal-turning-hook-stroke [symbol] horizontal-turning-rising-stroke [symbol] horizontal-turning-curved-stroke [symbol] horizontal-turning-turning-stroke [symbol] horizontal-turning-turning-turning-stroke [symbol] 1^{st} horizontal-turning-curved-hook-stroke [symbol] horizontal-hook-stroke [symbol] horizontal-left-falling-stroke [symbol] horizontal-turning-turning-left-falling-stroke [symbol] horizontal-turning-turning-turning-hook-stroke [symbol] horizontal-left-falling curved-hook-stroke [symbol] horizontal-slanting-hook-stroke [symbol] 2^{nd} horizontal-turning-curved-hook-stroke [symbol] vertical-turning-stroke [symbol] vertical-curved-hook-stroke [symbol] vertical-rising-stroke [symbol] vertical-curve-stroke [symbol] vertical-turning-turning-stroke [symbol] vertical-turning-left-falling-stroke [symbol] vertical-turning-turning-hook-stroke [symbol] slanting-hook-stroke [symbol] curved-hook-stroke [symbol] and lying-hook-stroke [symbol] .

Preferably, both of the mentioned stroke-type-code-element of initial stroke and the stroke-type-code-element of final stroke are respectively divided into six types totally including horizontal-type stroke-code-element, vertical-type stroke-code-element, left-falling-type stroke-code-element, dot-type stroke-code-element, right-falling-type stroke-code-element, and turning-type stroke-code-element, wherein the horizontal-type stroke-code-elements are allocated to the key element F, the vertical-type stroke-code-elements are allocated to the key element H, the left-falling-type stroke-code-elements are allocated to the key element J, the dot-type stroke-code-elements are allocated to the key element A, the right-falling-type stroke-code-elements are allocated to the key element K, and the turning-type stroke-code-elements are allocated to the key element S, and correspondingly thereto, both of the stroke-type-code-element of initial stroke and the code element for the of final stroke are one letter, respectively.

Preferably, the horizontal-type strokes are divided into horizontal-stroke [symbol] and rising-stroke [symbol] the vertical-type strokes are divided into vertical-stroke [symbol] and vertical-hook-stroke [symbol] the left-falling-type strokes are divided into left-falling-stroke [symbol] left-falling-turning-stroke [symbol] and left-falling-dot-stroke [symbol] the dot-type strokes are divided into left-dot-stroke [symbol] and right-dot-stroke [symbol] the right-falling-type strokes are divided into right-falling-stroke [symbol] and flattened-right-falling-stroke [symbol] and the turning-type strokes are divided into horizontal-turning-stroke [symbol] horizontal-turning-hook-stroke [symbol] horizontal-turning-rising-stroke [symbol] horizontal-turning-curve-stroke [symbol] horizontal-turning-turning-stroke [symbol] horizontal-turning-turning-turning-stroke [symbol] 1^{st} horizontal-turning-curved-hook-stroke [symbol] horizontal-hook-stroke [symbol] horizontal-left-falling-stroke [symbol] horizontal-turning-turning-left-falling-stroke [symbol] horizontal-turning-turning-turning-hook-stroke [symbol] horizontal-left-falling-curved-hook-stroke [symbol] horizontal-slanting-hook-stroke [symbol] 2^{nd} horizontal-turning-curved-hook-stroke [symbol] vertical-turning-stroke [symbol] vertical-curved-hook-stroke [symbol] vertical-rising-stroke [symbol] vertical-curve-stroke [symbol] vertical-turning-turning-stroke [symbol] vertical-turning-left-falling-stroke [symbol] vertical-turning-turning-hook-stroke [symbol] slanting-hook-stroke [symbol] curved-hook-stroke [symbol] and lying-hook-stroke

[symbol]

Preferably, both the mentioned stroke-type-code-elements of initial strokes and the stroke-type-code-elements of final strokes are respectively divided into the horizontal-type stroke-code-elements, the vertical-type stroke-code-elements, the left-falling-type stroke-code-elements, the dot-type stroke-code-elements, the right-falling-type stroke-code-elements, the horizontal-turning-vertical-type stroke-code-elements, the horizontal-turning-curve-type stroke-code-elements, the vertical-turning-type stroke-code-elements, and the other-type stroke-code-elements, nine types in total, wherein the horizontal-type stroke-code-elements are allocated to the key element F, the vertical-type stroke-code-elements are allocated to the key element H, the left-falling-type stroke-code-elements are allocated to the key element J, the dot-type stroke-code-elements are allocated to the key element A, the right-falling-type stroke elements are allocated to the key element K, the horizontal-turning-vertical-type stroke-code-elements are allocated to the key element G, the horizontal-turning-curve-type stroke-code-elements are allocated to the key element D, the vertical-turning-type stroke-code-elements are allocated to the key element L, and the other-type stroke-code-elements are allocated to the key element S, and correspondingly thereto, both of the mentioned stroke-type-code-element of the initial stroke and the stroke-type-code-element of the final stroke are one letter, respectively.

Preferably, the horizontal-type strokes are divided into horizontal-stroke [symbol] and rising-stroke [symbol] and their code elements for the stroke respectively correspond to letters F plus digital number 1 and letter F plus digital number 2.

The vertical-type strokes are divided into vertical-stroke [symbol] and vertical-hook-stroke [symbol] and their stroke-code-elements respectively correspond to letter H plus digital number 1 and letter H plus digital number 2.

The left-falling-type strokes are divided into left-falling-stroke [symbol] left-falling-turning-stroke [symbol] and left-falling-dot-stroke [symbol] and their code elements for the stroke respectively correspond to letter J plus digital number 1, letter J plus digital number 2, and letter J plus letter 3.

The dot-type strokes are divided into left-dot-stroke [symbol] and right-dot-stroke [symbol] and their code elements for stroke respectively correspond to letter A plus digital number 1 and letter A plus digital number 2.

The right-falling-type strokes are divided into right-falling-stroke [symbol] and flattened-right-falling-stroke [symbol] and their code elements for stroke respectively correspond to letter K plus digital number 1 and letter K plus digital number 2.

The horizontal-turning-vertical-type strokes are divided into horizontal-turning-stroke [symbol] horizontal turning hook [symbol] horizontal-turning-rising-stroke [symbol] horizontal-turning-curve-stroke [symbol] horizontal-turning-turning-stroke [symbol] horizontal-turning-turning-turning-stroke [symbol] 1^{st} horizontal-turning-curved-hook-stroke [symbol] and their code elements for stroke respectively correspond to the letter G plus digital number 1, letter G plus digital number 2, letter G plus digital number 3, letter G plus digital number 4, and letter G plus digital number 5, letter G plus digital number 6, and letter G plus digital number 7.

The horizontal-turning-curve-type strokes are divided into horizontal-hook-stroke [symbol] horizontal-left-falling-stroke [symbol] horizontal-turning-turning-left-falling-stroke [symbol] horizontal-turning-turning-turning-hook-stroke [symbol] horizontal-left-falling-curved-hook-stroke [symbol] horizontal slanting-hook-stroke [symbol] and 2^{nd} horizontal-turning-curved-hook-stroke [symbol] and their code elements for stroke respectively correspond to letter D plus digital number 1, letter D plus digital number 2, letter D plus digital number 3, letter D plus digital number 4, letter D plus digital number 5, letter D plus digital number 6, and letter D plus digital number 7.

The vertical-turning-type strokes are divided into vertical-turning-stroke [symbol] vertical-curved-hook-stroke [symbol] vertical-rising-stroke [symbol] vertical-curve-stroke [symbol] vertical-turning-turning-stroke [symbol] vertical-turning-left-falling-stroke [symbol] and vertical-turning-turning-hook-stroke [symbol] and their code elements for stroke respective correspond to letter L plus digital number 1, letter L plus digital number 2, letter L plus digital number 3, letter L plus digital number 4, letter L plus digital number 5, letter L plus digital number 6, and letter L plus digital number 7.

Other strokes are divided into slanting-hook-stroke [symbol] curved-hook-stroke [symbol] and lying-hook-stroke [symbol] and their code elements for stroke respectively correspond to letter S plus digital number 1, letter S plus digital number 2, and letter S plus digital number 3.

Correspondingly thereto, each of the mentioned code elements for the stroke is one letter plus one digital number.

Preferably, a step, for generating multiple optional characters and making digital numbers correspond to the optional characters, as well as selecting the characters to be entered by use of digit keys from the optional characters, is further included.

The useful effect of this invention lies in the fact that through the above input method, the beginners/learners of the Chinese language are allowed to review the pronunciation of this Chinese character at the same time when it is entered, and to review the shape of the Chinese character through memory of the initial stroke and the final stroke of the Chinese character, thus enhancing the memory effect and expediting the progress on learning the Chinese characters.

### DESCRIPTION OF THE DRAWINGS

FIG. 1 is the cross reference list between stroke-type-code-elements and key elements of the Chinese character input method according to a embodiment of this invention.

FIG. 2 is the cross reference list between stroke-type-code-elements and key elements of the Chinese character input method according to another embodiment of this invention.

FIG. 3 is the cross reference list between stroke-type-code-elements and key elements of the Chinese character input method according to the third embodiment of this invention.

FIG. 4 is the cross reference list between stroke-type-code-elements and key elements of the Chinese character input method according to the forth embodiment of this invention.

FIG. 5 is the structure chart showing the computer keyboard for the Chinese character input method according to this invention.

FIG. 6 is the structure chart showing the mobile phone keypad for the Chinese character input method according to this invention.

### MODE FOR CARRYING OUT THE INVENTION

26 Pinyin letters, corresponding to the 26 English letter keys on the English keyboard, of the “Chinese Pinyin Scheme” have been used for this Invention.

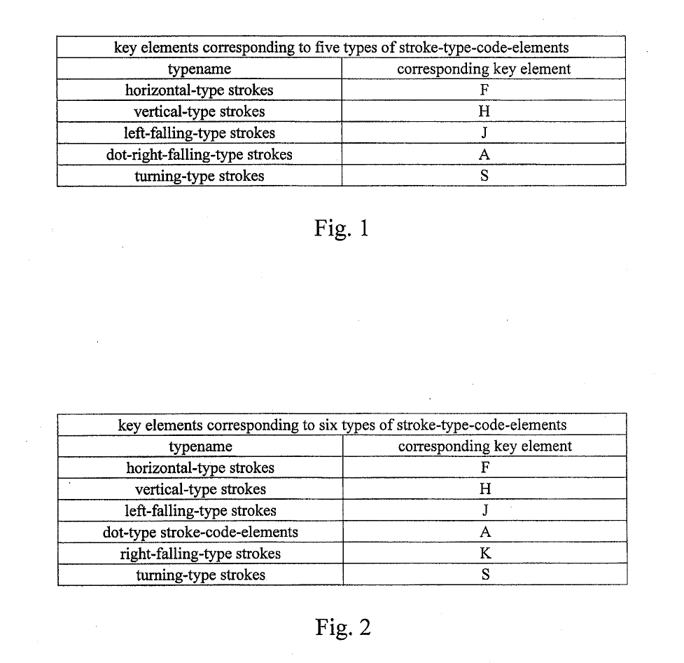

The strokes of the Chinese characters are further divided into five types, namely, horizontal-type strokes, vertical-type strokes, left-falling-type strokes, dot-right-falling-type strokes, and turning-type strokes. The code elements of these five types of strokes are called as the “type-code-elements” of the strokes, and may be allocated to any five English letter keys on a general English keyboard. One of the feasible allocation methods is: the horizontal-type stroke-code-elements are allocated to F, the vertical-type stroke-code-elements are allocated to H, the left-falling-type stroke-code-elements are allocated to J, the dot-right-falling-type stroke-code-elements are allocated to A, and the turning-type stroke-code-elements are allocated to S. FIG. 1 has indicated such corresponding relations:

the horizontal-type strokes are divided into horizontal-stroke [symbol] and rising-stroke

[symbol]

the vertical-type strokes are divided into vertical-stroke [symbol] and vertical-hook-stroke

[symbol]

the left-falling-type strokes are divided into left-falling-stroke [symbol] left-falling-turning-stroke [symbol] and left-falling-dot-stroke

[symbol]

the dot-right-falling-type strokes are divided into left-dot-stroke [symbol] right-dot-stroke [symbol] right-falling-stroke [symbol] and flattened-right-falling-stroke

[symbol]

the turning-type strokes are divided into horizontal-turning-stroke [symbol] horizontal-turning-hook-stroke [symbol] horizontal-turning-rising-stroke [symbol] and horizontal-turning-curve-stroke [symbol] horizontal-turning-turning-stroke [symbol] horizontal-turning-turning-turning-stroke [symbol] 1^{st} horizontal-turning-curved-hook-stroke [symbol] horizontal-hook-stroke [symbol] horizontal-left-falling-stroke [symbol] horizontal-turning-turning-left-falling-stroke [symbol] horizontal-turning-turning-turning-hook-stroke [symbol] horizontal-left-falling-curved-hook-stroke [symbol] horizontal-slanting-hook-stroke [symbol] 2^{nd} horizontal-turning-curved-hook-stroke [symbol] vertical-turning-stroke [symbol] vertical-curved-hook-stroke [symbol] vertical-rising-stroke [symbol] vertical-curve-stroke [symbol] vertical-turning-turning-stroke [symbol] vertical-turning-left-falling-stroke [symbol] vertical-turning-turning-hook-stroke [symbol] slanting-hook-stroke [symbol] curve-hook-stroke [symbol] and lying-hook-stroke [symbol] .

Or the strokes of the Chinese characters are divided into six types, namely, horizontal-type strokes, vertical-type strokes, left-falling-type strokes, dot-type strokes, right-falling-type strokes, and turning-type strokes. The code elements of these six types of strokes are called as the “type-code-elements” of the strokes, and may be allocated to any six English letter keys on a general English keyboard. One of the feasible distribution methods is:

the horizontal-type stroke-code-elements are allocated to F, the vertical-type stroke-code-elements are allocated to H, the left-falling-type stroke-code-elements are allocated to J, the dot-type stroke-code-elements are allocated to A, the right-falling-type stroke-code-elements are allocated to K, and the turning-type stroke-code-elements are allocated to S. FIG. 2 has indicated such corresponding relations:.

the horizontal-type strokes are divided into horizontal-stroke [symbol] and rising-stroke

[symbol]

the vertical-type strokes are divided into vertical-stroke [symbol] and vertical-hook-stroke

[symbol]

the left-falling-type strokes are divided into left-falling-stroke [symbol] left-falling-turning-stroke [symbol] and left-falling-dot-stroke

[symbol]

the dot-type strokes are divided into left-dot-stroke [symbol] and right-dot-stroke

[symbol]

the right-falling-type strokes are divided into right-falling-stroke [symbol] and flattened-right-falling-stroke

[symbol]

The turning-type strokes are divided into horizontal-turning-stroke [symbol] horizontal-turning-hook-stroke [symbol] horizontal-turning-rising-stroke [symbol] horizontal-turning-curve-stroke [symbol] horizontal-turning-turning-stroke [symbol] horizontal-turning-turning-turning-stroke [symbol] 1^{st} horizontal-turning-curved-hook-stroke [symbol] horizontal-hook-stroke [symbol] horizontal-left-falling-stroke [symbol] horizontal-turning-turning-left-falling-stroke [symbol] horizontal-turning-turning-turning-hook-stroke [symbol] horizontal-left-falling-curved-hook-stroke [symbol] horizontal-slanting-hook-stroke [symbol] 2^{nd} horizontal-turning-curved-hook-stroke [symbol] vertical-turning-stroke [symbol] vertical-curved-hook-stroke [symbol] vertical-rising-stroke [symbol] vertical-curve-stroke [symbol] vertical-turning-turning-stroke [symbol] vertical-turning-left-falling-stroke [symbol] and vertical-turning-turning-hook-stroke [symbol] slanting-hook-stroke [symbol] curved-hook-stroke [symbol] and lying-hook-stroke

[symbol]

Or the strokes of the Chinese characters are divided into nine types, namely, horizontal-type strokes, vertical-type strokes, left-falling-type strokes, dot-type strokes, right-falling-type strokes, horizontal-turning-vertical-type strokes, horizontal-turning-curve-type strokes, vertical-turning-type strokes, and other-type strokes.

The code elements of these nine stroke types are called as the “type-code-elements” for the strokes, and may be allocated to any nine English letter keys on a general English keyboard. One of the feasible allocation methods is:

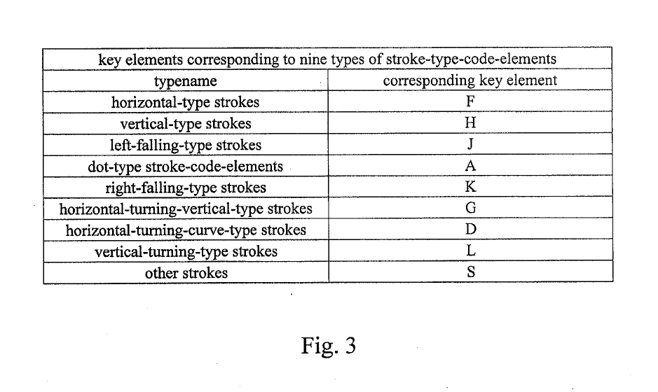

the horizontal-stroke-code-elements are allocated to F, the vertical-type stroke-code-elements are allocated to H, the left-falling-type stroke-code-elements are allocated to J, the dot-type stroke-code-elements are allocated to A, the right-falling-type stroke-code-elements are allocated to K, the horizontal-turning-vertical-type stroke-code-elements are allocated to G, the horizontal-turning-curve-type stroke-code-elements are allocated to D, the vertical-turning-type stroke-code-elements are allocated to L, and the other-type stroke-code-elements are allocated to S. FIG. 3 has indicated such corresponding relations:

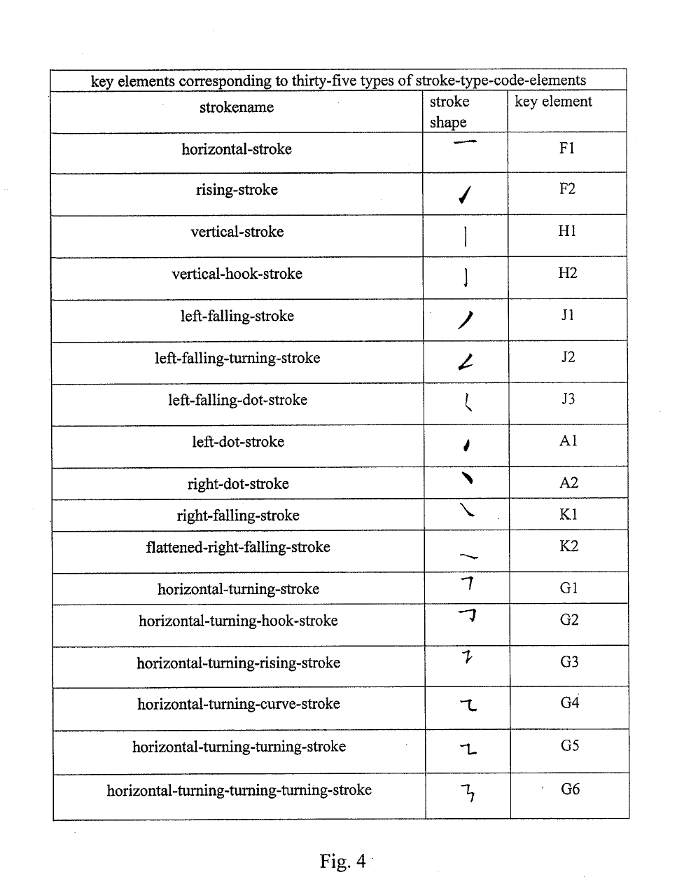

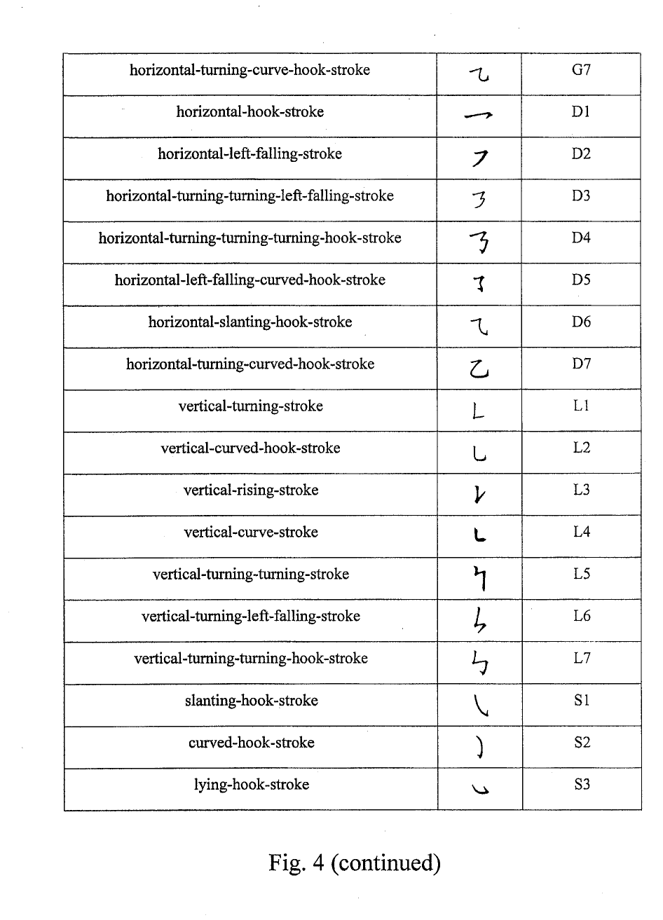

the abovementioned nine types of strokes may be further subdivided into 35 types of ultimate strokes based on the following approach. The code elements for stroke of each type of ultimate stroke are composed of the digital code elements that play the sorting function added with one digital number to the type-code-element affiliated to the stroke type of this stroke. FIG. 4 has indicated such corresponding relations, wherein:

the horizontal-type strokes are divided into horizontal-stroke [symbol] and rising-stroke [symbol] and their code elements for stroke respectively correspond to letter F plus digital number 1, and letter F plus digital number 2.

the vertical-type strokes are divided into vertical-stroke [symbol] and vertical-hook-stroke [symbol] and their code elements for stroke respectively correspond to letter H plus digital number 1, and letter H plus digital number 2.

the left-falling-type strokes are divided into left-falling-stroke [symbol] left-falling-turning-stroke [symbol] and left-falling-dot-stroke [symbol] and their code elements for stroke respectively correspond to letter J plus digital number 1, letter J plus digital number 2, and letter J plus digital number 3.

the dot-type strokes are divided into left-dot-stroke [symbol] and right-dot-stroke [symbol] and their code elements for stroke respectively correspond to letter A plus digital number 1 and letter A plus digital number 2.

the right-falling-type strokes are divided into right-falling-stroke [symbol] and flattened-right-falling-stroke [symbol] and their code elements for stroke respectively correspond to letter K plus digital number 1 and letter K plus digital number 2.

the horizontal-turning-vertical-type strokes are divided into horizontal-turning-stroke [symbol] horizontal-turning-hook-stroke [symbol] horizontal-turning-rising-stroke [symbol] horizontal-turning-curve-stroke [symbol] horizontal-turning-turning-stroke [symbol] horizontal-turning-turning-turning-stroke [symbol] and 1^{st} horizontal-turning-curved-hook-stroke [symbol] and their code elements for stroke respectively correspond to letter G plus digital number 1, letter G plus digital number 2, letter G plus digital number 3, letter G plus digital number 4, letter G plus digital number 5, letter G plus digital number 6, and letter G plus digital number 7.

The horizontal-turning-curve-type strokes are divided into horizontal-hook-stroke [symbol] horizontal-left-falling-stroke [symbol] horizontal-turning-turning-left-falling-stroke [symbol] horizontal-turning-turning-turning-hook-stroke [symbol] horizontal-left-falling-curved-hook-stroke [symbol] horizontal-slanting-hook-stroke [symbol] and 2^{nd} horizontal-turning-curved-hook-stroke [symbol] and their code elements for stroke respectively correspond to letter D plus digital number 1, letter D plus digital number 2, letter D plus digital number 3, letter D plus digital number 4, letter D plus digital number 5, letter D plus digital number 6, and letter D plus digital number 7.

The vertical-turning-type strokes are divided into vertical-turning-stroke [symbol] vertical-curved-hook-stroke [symbol] vertical-rising-stroke [symbol] vertical-curve-strke [symbol] vertical-turning-turning-stroke [symbol] vertical-turning-left-falling-stroke [symbol] and vertical-turning-turning-hook-stroke [symbol] and their code elements for stroke respectively correspond to letter L plus digital number 1, letter L plus digital number 2, letter L plus digital number 3, letter L plus digital number 4, letter L plus digital number 5, letter L plus digital number 6, and letter L plus digital number 7.

The other-type strokes are divided into slanting-hook-stroke [symbol] curved-hook-stroke [symbol] and lying-hook-stroke [symbol] and their code elements for stroke respectively correspond to letter S plus digital number 1, letter S plus digital number 2, and letter S plus digital number 3.

The input methods in this Invention may refer to any kind of the following embodiments, namely,

the 1^{st} kind is the 5-Radical-Type-Stroke Initial-Final-Stroke Quanpin Input:

input the type-code-element (1-digit letter) for the stroke that corresponds to the initial stroke of the Chinese character to be entered;

input the type-code-element (1-digit letter) for the stroke that corresponds to the final stroke of the Chinese character to be entered; and

sequentially input all the Pinyin-letters-code-elements that form the Pinyin of the Chinese character to be entered.

The 2^{nd} kind is the 5-Radical-Type-Stroke Initial-Stroke Quanpin Input:

input the type-code-element (1-digit letter) for the stroke that corresponds to the initial stroke of the Chinese character to be entered; and,

sequentially input all the Pinyin-letters-code-elements that form the Pinyin of the Chinese character to be entered.

The 3^{rd} kind is the 6-Radical-Type-Stroke Initial-Final-Stroke Quanpin Input:

input the type-code-element (1-digit letter) for the stroke that corresponds to the initial stroke of the Chinese character to be entered;

input the type-code-element (1-digit letter) for the stroke that corresponds to the final stroke of the Chinese character waiting to be entered; and,

sequentially input all the Pinyin-letters-code-elements that form the Pinyin of the Chinese character waiting to be entered.

The 4^{th} kind is the 6-Radical-Type-Stroke Initial-Stroke Quanpin Input:

input the type-code-element (1-digit letter) for the stroke that corresponds to the initial stroke of the Chinese character to be entered; and

sequentially input all the Pinyin-letters-code-elements that form the Pinyin of the Chinese character waiting to be entered.

The 5^{th} kind is the 9-Radical-Type-Stroke Initial-Final-Stroke Quanpin Input:

input the type-code-element (1-digit letter) for the stroke that corresponds to the initial stroke of the Chinese character to be entered;

input the type-code-element (1-digit letter) for the stroke that corresponds to the final stroke of the Chinese character to be entered; and,

sequentially input all the Pinyin-letters-code-elements that form the Pinyin of the Chinese character waiting to be entered.

The 6^{th} kind is the 9-Radical-Type-Stroke Initial-Stroke Quanpin Input:

input the type-code-element (1-digit letter) for the stroke that corresponds to the initial stroke of the Chinese character to be entered; and

sequentially input all the Pinyin-letters-code-elements that form the Pinyin of the Chinese character to be entered.;

The 7^{th} kind is the 35-Stroke Initial-Final-Stroke Quanpin Input:

input the code elements (1-digit letter plus 1-digit number) for the stroke that corresponds to the initial stroke of the Chinese character to be entered;

input the code elements (1-digit letter plus 1-digit number) for the stroke that corresponds to the final stroke of the Chinese character to be entered; and,

sequentially input all the Pinyin-letters-code-elements that form the Pinyin of the Chinese character waiting to be entered.

The 8^{th} kind is the 35-Stroke Initial-Stroke Quanpin Input:

input the code elements (1-digit letter plus 1-digit number) for the stroke that corresponds to the initial stroke of the Chinese character to be entered; and,

sequentially input all the Pinyin-letters-code-elements that form the Pinyin of the Chinese character to be entered.

For example, as the initial stroke of the Chinese character [symbol] is horizontal-turning-stroke [symbol] and the final stroke is right-falling-stroke [symbol] all the Pinyin-letters-code-elements are sequentially “Z”, “H”, “A”, “N”, and “G”.

Thus, if the “5-Radical-Type-Stroke Initial-Final-Stroke Quanpin Input” method of the 1^{st} kind is followed, the corresponding key elements required to click are: “S”, “A”, “Z”, “H”, “A”, “N”, and “G”.

If the “5-Radical-Type-Stroke Initial-Stroke Quanpin Input” method of the 2^{nd} kind is followed, the corresponding key elements required to click are: “S”, “Z”, “H”, “A”, “N”, and “G”.

If the “6-Radical-Type-Stroke Initial-Final-Stroke Quanpin Input” method of the 3^{rd} kind is followed, the corresponding key elements required to click are: “S”, “K”, “Z”, “H”, “A”, “N”, and “G”.

If the “6-Radical-Type-Stroke Initial-Stroke Quanpin Input” method of the 4^{th} kind is followed, the corresponding key elements required to click are: “S”, “Z”, “H”, “A”, “N”, and “G”.

If the “9-Radical-Type-Stroke Initial-Final-Stroke Quanpin Input” method of the 5^{th} kind is followed, then the corresponding key elements required to click are: “G”, “K”, “Z”, “H”, “A”, “N”, and “G”.

If the “9-Radical-Type-Stroke Initial-Stroke Quanpin Input” method of the 6^{th} kind is followed, the corresponding key elements required to click are: “G”, “Z”, “H”, “A”, “N”, and “G”.

If the “35-Stroke Initial-Final-Stroke Quanpin Input” method of the 7^{th} kind is followed, the corresponding key elements required to click are: “G”, “1”, “K”, “1”, “Z”, “H”, “A”, “N”, and “G”.

If the “35-Stroke Initial-Stroke Quanpin Input” method of the 8^{th} kind is followed, the corresponding key elements required to click are: “G”, “1”, “Z”, “H”, “A”, “N”, and “G”.

The optional word (the Chinese character [symbol] is acquirable in case of using all the above eight methods.

Since there are only two words in the Chinese characters that only have one stroke, respective, as [symbol] and [symbol] and they do not have final strokes, the “specially configured superimposed code”, that is, letter I, for these two words is specially defined in this Invention, as the substitution code element for the final strokes of these two words. Thereby, the method of the “5-Radical-Type-Stroke Initial-Final-Stroke Quanpin Input” for [symbol] is “FIyi”, the method of the “6-Radical-Type-Stroke Initial-Final-Stroke Quanpin Input” for [symbol] is “FIyi”, the method of the “9-Radical-Type-Stroke Initial-Final-Stroke Quanpin Input” for [symbol] is “FIyi”, and the method of the “35-Stroke Initial-Final-Stroke Quanpin Input” for [symbol] is “F1IIyi”. The method of the “5-Radical-Type-Stroke Initial-Final-Stroke Quanpin Input” for [symbol] is “SIyi”, the “6-Radical-Type-Stroke Initial-Final-Stroke Quanpin Input” method for [symbol] is “SIyi”, the “9-Radical-Type-Stroke Initial-Final-Stroke Quanpin Input” method for [symbol] is “DIyi”, and the method of the “35-Stroke Initial-Final-Stroke Quanpin Input” for [symbol] is “D7IIyi”.

In addition, it shall be noted that not only the simplified Chinese characters, but also the traditional Chinese characters can be entered by the shape-sound code input methods for Chinese characters of this Invention. As the pronunciations of the simplified Chinese characters and the traditional Chinese characters are the same, and their only difference lies in the character shapes, therefore, the similarities and differences are only represented in the stroke-code-element of the initial stroke, the stroke-type-code-element of the initial stroke and the stroke-code-element of the final stroke, and the stroke-type-code-element of the final stroke in terms of input.

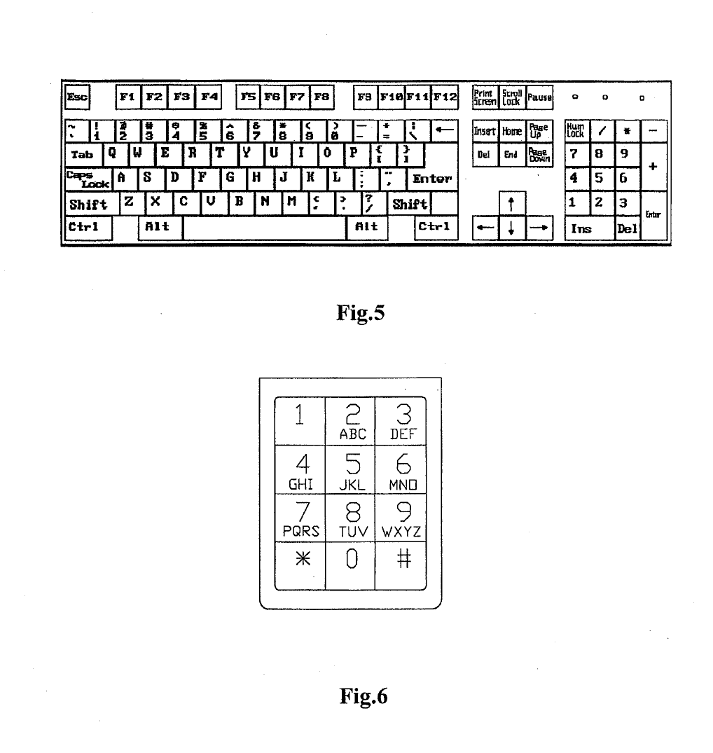

FIG. 5 shows a kind of common schematic drawing for the layout of the standard 104-key keyboard, and in reference to FIG. 5, the letter rows and the number row are generally available for the layout of keys on a standard keyboard. However, the skilled in this field may understand that other keyboards with such key definitions may also be used. In addition, the keyboards achieved by digit keyboard, mobile phone keypad, and touch screen are usable as well. The input of code elements may be achieved not only through finger click or touch of corresponding key elements, but also through click of corresponding key elements by means of tools or in the form of writing by means of tools.

FIG. 6 shows a kind of structure for mobile phone keypad to achieve the input of this invention, and on this keypad of mobile phone, the type-code-elements for the strokes of the 9 types of strokes F, H, J, A, K, G, D, L, and S are respectively substituted by the digit keys from 1 to 9, so that the input may be achieved on the mobile phone by this invention.

The previous statement on the specification about the embodiments to this invention only aims at demonstration and description, and not aims to exhaust all the implementation approaches or to limit the invention to the already-revealed embodiments or certain established form. On these grounds, the abovementioned description should be regarded as demonstrative rather than restrictive. Obviously, many modifications and variations are visible to the skilled in this field. The selection and the description about respective embodiments is only a way of interpretation about the principles of this invention and the optimal practical application of this invention in a clearest style, so as to enable the skilled in this field to understand the applicability of this invention to the expected special applications or the achievement of various implementation examples and respective variations. The scope of this invention is defined by the Claims and its equivalent changes. In the Claims, only when separately specified, all the terms shall be interpreted into their broadest meanings. It is advisable to be aware that the skilled in this field may make changes to the embodiments, as far as the scope of this embodiment defined in the Claims is not deviated. Moreover, no matter whether or not the claims have explicitly described certain constituents and component parts, it is not expect in all cases to offer theses constituents and component parts disclosed here to the widely-known fields.

1. A Chinese character input method adapting for teaching, characterized in that, comprising the steps of:
inputting at least the stroke-type-code-element or the stroke-code-element that corresponds to the initial stroke of the Chinese character to be entered; and
sequentially inputting all the Pinyin-letters-code-elements that form the Pinyin of the Chinese character to be entered.

2. The Chinese character input method adapting for teaching as defined in claim 1, characterized in that,
after the step of the inputting the stroke-type-code-element or the stroke-code-element that corresponds to the initial stroke of the Chinese character to be entered, and before the step of sequentially inputting all the Pinyin-letters-code-elements that form the Pinyin of the Chinese character to be entered, a step is further included for inputting the stroke-type-code-element or the stroke-code-element that corresponds to the final stroke of the Chinese character to be entered.

3. The Chinese character input method adapting for teaching as defined in claim 2, characterized in that:
the input of mentioned code elements may be achieved through finger click, or touch of corresponding key elements, and may also be achieved through click of corresponding key elements by means of tools or in the form of writing by means of tools.

4. The Chinese character input method adapting for teaching as defined in claim 3, characterized in that:
a step for generating multiple optional words and making digital numbers correspond to the optional words, as well as selecting the characters to be entered using the digit keys from the optional words, is further included.

5. The Chinese character input method adapting for teaching as defined in claim 1, characterized in that:
each of the stroke-type-code-element of the initial stroke and the stroke-type-code-element of the final stroke is divided into five types in total, including the horizontal-type stroke-code-elements, the vertical-type stroke-code-elements, the left-falling-type stroke-code-elements, the dot-and-right-falling-type stroke-code-elements, and the turning-type stroke-code-elements, wherein
the horizontal-type stroke-code-elements are allocated to the key element F, the vertical-type stroke-code-elements are allocated to the key element H, the left-falling-type stroke-code-elements are allocated to the key element J, the dot-right-falling-type stroke elements are allocated to the key element A, and the turning-type stroke-code-elements are allocated to the key element S, and correspondingly thereto, the mentioned stroke-type-code-element are 1-digit letters.

6. The Chinese character input method adapting for teaching as defined in claim 5, characterized in that:
the horizontal-type strokes are divided into horizontal-stroke [symbol] and rising-stroke [symbol] the vertical-type strokes are divided into vertical-stroke [symbol] and vertical-hook-stroke [symbol] the left-falling-type strokes are divided into left-falling-stroke [symbol] left-falling-turning-stroke [symbol] and left-falling-dot-stroke [symbol] the dot-right-falling-type strokes are divided into left-dot-stroke [symbol] right-dot-stroke [symbol] right-falling-stroke [symbol] and flattened-right-falling-stroke [symbol] the turning-type strokes are divided into horizontal-turning-stroke [symbol] horizontal-turning-hook-stroke [symbol] horizontal-turning-rising-stroke [symbol] horizontal-turning-curve-stroke [symbol] horizontal-turning-turning-stroke [symbol] horizontal-turning-turning-turning-stroke [symbol] 1^{st} horizontal-turning-curve-hook-stroke [symbol] horizontal-hook-stroke [symbol] horizontal-left-falling-stroke [symbol] horizontal-turning-turning-left-falling-stroke [symbol] horizontal-turning-turning-turning-hook-stroke [symbol] horizontal-left-falling-curved-hook-stroke [symbol] horizontal-slanting-hook-stroke [symbol] 2^{nd} horizontal-turning-curved-hook-stroke [symbol] vertical-turning-stroke [symbol] vertical-curved-hook-stroke [symbol] vertical-rising-stroke [symbol] vertical-curve-stroke [symbol] vertical-turning-turning-stroke [symbol] vertical-turning-left-falling-stroke [symbol] vertical-turning-turning-hook-stroke [symbol] slanting-hook-stroke [symbol] curved-hook-stroke [symbol] and lying-hook-stroke

[symbol]

7. The Chinese character input method adapting for teaching as defined in claim 6, characterized in that:
letter I is the substitution code element for the Chinese characters [symbol] and

[symbol]

8. The Chinese character input method adapting for teaching as defined in claim 1, characterized in that:
each of the mentioned stroke-type-code-element of initial stroke and the stroke-type-code-element of final stroke is divided into six types in total, including the horizontal-type stroke-code-elements, the vertical-type stroke-code-elements, the left-falling-type stroke-code-elements, the dot-type stroke-code-elements, the right-falling-type stroke-code-elements, and the turning-type stroke-code-element, therein, the horizontal-type stroke-code-elements are allocated to the key element F, the vertical-type stroke-code-elements are allocated to the key element H, the left-falling-type stroke-code-elements are allocated to the key element J, the dot-type stroke-code-elements are allocated to the key element A, the right-falling-type stroke-code-elements are allocated to the key element K, and the turning-type stroke-code-elements are allocated to the key element S, and correspondingly thereto, both of the stroke-type-code-element of initial stroke and the code element for the of final stroke are 1-digit letters.

9. The Chinese character input method adapting for teaching as defined in claim 8, characterized in that:
the horizontal-type strokes are divided into horizontal-stroke [symbol] and rising-stroke [symbol] the vertical-type strokes are divided into vertical-stroke [symbol] and vertical-hook-stroke [symbol] the left-falling-type strokes are divided into left-falling-stroke [symbol] left-falling-turning-stroke [symbol] and left-falling-dot-stroke [symbol] the dot-type strokes are divided into left-dot-stroke [symbol] and right-dot-stroke [symbol] the right-falling-strokes are divided into right-falling-stroke [symbol] and flattened-right-falling-stroke [symbol] the turning-type strokes are divided into horizontal-turning-stroke [symbol] horizontal-turning-hook-stroke [symbol] horizontal-turning-rising-stroke [symbol] horizontal-turning-curve-stroke [symbol] horizontal-turning-turning-stroke [symbol] horizontal-turning-turning-turning-stroke [symbol] 1^{st} horizontal-turning-curved-hook-stroke [symbol] horizontal-hook-stroke [symbol] horizontal-left-falling-stroke [symbol] horizontal-turning-turning-left-falling-stroke [symbol] horizontal-turning-turning-turning-hook-stroke [symbol] horizontal-left-falling-curved-hook-stroke [symbol] horizontal-slanting-hook-stroke [symbol] 2^{nd} horizontal-turning-curved-hook-stroke [symbol] vertical-turning-stroke [symbol] vertical-curved-hook-stroke [symbol] vertical-rising-stroke [symbol] vertical-curve-stroke [symbol] vertical-turning-turning-stroke [symbol] vertical-turning-left-falling-stroke [symbol] vertical-turning-turning-hook-stroke [symbol] slanting-hook-stroke [symbol] curved-hook-stroke [symbol] and lying-hook-stroke

[symbol]

10. The Chinese character input method adapting for teaching as defined in claim 9, it is characterized in that:
letter I is the substitution code element for the final strokes of [symbol] and

[symbol]

11. The Chinese character input method adapting for teaching as defined in claim 1, characterized in that:
each of the mentioned code element for stroke type of initial stroke and the code element for stroke type of final stroke includes horizontal-type stroke-code-elements, vertical-type stroke-code-elements, left-falling-type stroke-code-elements, dot-type stroke-code-elements, right-falling-type stroke-code-elements, horizontal-turning-vertical-type stroke-code-elements, horizontal-turning-curve-type stroke-code-elements, vertical-turning-type stroke-code-elements, and other-type stroke-code-elements, wherein
the horizontal-type stroke-code-elements are allocated to key element F; the vertical-type stroke-code-elements are allocated to key element H; the left-falling-type stroke-code-elements are allocated to key element J; the dot-type stroke-code-elements are allocated to key element A; the right-falling-type stroke-code-elements are allocated to key element K. The horizontal-turning-vertical-type stroke-code-elements are allocated to key element G; the horizontal-turning-curve-type stroke-code-elements are allocated to key element D; the vertical-turning-type stroke-code-elements are allocated to key element L; the other-type stroke-code-elements are allocated to key element S, and correspondingly thereto, both of the mentioned code element for stroke type of initial stroke and the code element for stroke type of final stroke are 1-digit letters.

12. The Chinese character input method adapting for teaching as defined in claim 11, characterized in that:
the horizontal-type strokes are divided into horizontal-stroke [symbol] and rising-stroke [symbol] and their stroke-code-elements respectively correspond to letter F plus digital number 1 and letter F plus digital number 2;
the vertical-type strokes are divided into vertical-stroke [symbol] and vertical-hook-stroke [symbol] and their stroke-code-elements respectively correspond to letter H plus digital number 1 and letter H plus digital number 2;
the left-falling-type strokes are divided into left-falling-stroke [symbol] left-falling-turning-stroke [symbol] and left-falling-dot-stroke [symbol] and their stroke-code-elements respectively correspond to letter J plus digital number 1, letter J plus digital number 2, and letter J plus digital number 3;
the dot-type strokes are divided into left-dot-stroke [symbol] and right-dot-stroke [symbol] and their stroke-code-elements respectively correspond to letter A plus digital number 1 and letter A plus digital number 2;
the right-falling-type strokes are divided into right-falling-stroke [symbol] and flattened-right-falling-stroke [symbol] and their stroke-code-elements respectively correspond to letter K plus digital number 1 and letter K plus digital number 2;
the horizontal-turning-vertical-type strokes are divided into horizontal-turning-stroke [symbol] horizontal-turning-hook-stroke [symbol] horizontal-turning-rising-stroke [symbol] horizontal-turning-curve-stroke [symbol] horizontal-turning-turning-stroke [symbol] horizontal-turning-turning-turning-stroke [symbol] and 1^{st} horizontal-turning-curved-hook-stroke [symbol] and their stroke-code-elements respectively correspond to letter G plus digital number 1, letter G plus digital number 2, letter G plus digital number 3, letter G plus digital number 4, letter G plus digital number 5, letter G plus digital number 6, and letter G plus digital number 7;
the horizontal-turning-curve-type strokes are divided into horizontal-hook-stroke [symbol] horizontal-left-falling-stroke [symbol] horizontal-turning-turning-left-falling-stroke [symbol] horizontal-turning-turning-turning-hook-stroke [symbol] horizontal-left-falling-curved-hook-stroke [symbol] horizontal-slanting-hook-stroke [symbol] and 2^{nd} horizontal-turning-curved-hook-stroke [symbol] and their stroke-code-elements respective correspond to letter D plus digital number 1, letter D plus digital number 2, letter D plus digital number 3, letter D plus digital number 4, letter D plus digital number 5, letter D plus digital number 6, and letter D plus digital number 7;
the vertical-turning-type strokes are divided into vertical-turning-stroke [symbol] vertical-curved-hook-stroke [symbol] vertical-rising-stroke [symbol] vertical-curve-stroke [symbol] vertical-turning-turning-stroke [symbol] vertical-turning-left-falling-stroke [symbol] and vertical-turning-turning-hook-stroke [symbol] and their stroke-code-elements respectively correspond to letter L plus digital number 1, letter L plus digital number 2, letter L plus digital number 3, letter L plus digital number 4, letter L plus digital number 5, letter L plus digital number 6, and letter L plus digital number 7;
the other-type strokes are divided into slanting-hook-stroke [symbol] curved-hook-stroke [symbol] and lying-hook-stroke [symbol] and their stroke-code-elements respectively correspond to letter S plus digital number 1, letter S plus digital number 3, and letter S plus digital number 3;
Correspondingly thereto, each of the mentioned stroke-code-elements is 1-digit letter plus 1-digit number.

13. The Chinese character input method adapting for teaching as defined in claim 12, characterized in that:
letter I is the substitution code element for the final strokes of [symbol] and [symbol]
